(19) United States
(12) Patent Application Publication
(10) Pub. No.: US 2011/0268308 A1
(43) Pub. Date: Nov. 3, 2011

(54) Partially Occluding Ergonomic Earbud Adapter

(76) Inventor: Rafael Vasquez, San Mateo, CA (US)

(21) Appl. No.: 13/098,452

(22) Filed: Apr. 30, 2011

Related U.S. Application Data
(60) Provisional application No. 61/330,288, filed on Apr. 30, 2010.

(51) Int. Cl. H04R 1/10

(52) U.S. Cl. 381/380

(57) ABSTRACT

A partially occluding ergonomic earbud adapter is formed from low durometer materials. The exterior of the adapter is frustoconical and tear-drop shaped and formed with several fluted recesses which set apart finger-like flanges extending from an open base toward the tip of the adapter. The ergonomic flanges grip the inside of the ear canal as a result of elastic restoring forces of the flanges against each other and against the ear canal to form an ergonomic seal partially occluding sound from the ear canal while providing isolation. The inside wall of the adapter is formed to enclose and secure the earphone in a parabolic concavity formed by an undercut rib at the base. The cavity is abutted by a cylindrical channel extending through the adapter to an orifice at the tip to deliver high fidelity audio into a user's ear canal from the headset or another audio listening device.

### CROSS-REFERENCE TO RELATED APPLICATION

This application claims the benefit of the priority date of earlier filed U.S. Provisional Patent Application Ser. No. 61/330,288, filed Apr. 30, 2010 for Rafael Vasquez titled, A Partially Occluding Ergonomic Earbud Adapter, incorporated herein by reference in its entirety.

### BACKGROUND OF THE INVENTION

Earbuds, for the most part, are small speakers inserted into the human ear but the term may also be used to refer to the soft cushioned tips that cover these speakers that are inserted into the human ear. They are used for audio applications in mobile phone Bluetooth earpieces, iPod earphones, personal computer earpieces and many other multimedia devices today. Most earbuds are shaped similar to a small disk and therefore fit best in the concha of the ear auricle. However, unlike hearing aid earbuds which may be custom fit to a user's ear, commercially available earbuds, more often than not, may either be loose fit and allow noisy interference to the user or be pressure fit into the ear and cause discomfort to the user over long periods of use. Also, fully occluding earbuds can muffle audio fidelity and create a safety hazard for users engaged in activities while using their earpiece.

### SUMMARY OF THE INVENTION

A partially occluding ergonomic earbud adapter for use on headsets, speakers or other audio listening devices is disclosed herein. The earbud adapter includes a frustoconical teardrop-like exterior with multiple fluted recesses therein which set apart arcuate finger-like flanges extending near an open base of the adapter to a tip thereof, the exterior defining one side of a device wall. The adapter wall extends from the base to an orifice defined in the tip. An inside of the wall defines a radial channel extending cylindrically inward from the orifice and an adjacent parabolic cavity extends to the base. The adapter comprises a rib protruding from the inside wall near the base. The rib is configured to fit into a circumferential notch in the earbud of a headset and secure the earbud into the cavity and thus enable a user to position the headset into an ear canal to channel sound from the earbud adapter out the orifice and into the ear canal. In an embodiment, a cylindrical skirt shares an exterior wall with the base and extends a height of the base, the skirt is configured to extend from the base over the neck of the headset or other audio listening device.

A method of setting an earbud adapter for a headset or another audio listening device into an ear canal is also disclosed. The method includes providing a frustoconical teardrop-like earbud adapter with multiple fluted recesses therein which set apart arcuate finger-like flanges extending near an open base of the adapter toward a tip and an orifice defined therein. The method also includes inserting the adapter tip-first into a concha of an ear auricle and applying a manual digital pressure to the adapter, the pressure directed toward an ear canal within the concha. The method further includes securing the adapter inside the ear canal through a tension between the elastic restoring forces of the flanges against each other and against the inside of the ear canal, the tension resulting from the applied pressure.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a top perspective view of the earbud adapter in accordance with an embodiment of the present disclosure.

FIG. 2 depicts a bottom perspective view of the earbud adapter in accordance with an embodiment of the present disclosure.

FIG. 3a depicts a side elevational view of a skirtless earbud adapter in accordance with an embodiment of the present disclosure.

FIG. 3b depicts a side elevational view of a skirted earbud adapter in accordance with an embodiment of the present disclosure.

FIG. 4 depicts a top elevational view of the earbud adapter in accordance with an embodiment of the present disclosure.

FIG. 5 depicts a bottom elevational view of the earbud adapter in accordance with an embodiment of the present disclosure.

FIG. 6a depicts a radial cross-sectional view of an earbud adapter through section 6 of FIG. 4 in accordance with an embodiment of the present disclosure.

FIG. 6b depicts a radial cross-sectional view of a skirtless earbud adapter through section 6 of FIG. 4 in accordance with an embodiment of the present disclosure.

FIG. 7 depicts a flow chart of a method for setting an earbud adapter into an ear canal in accordance with an embodiment of the present disclosure.

Throughout the description, similar reference numbers may be used to identify similar elements appearing in multiple figures.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

An earbud is a small headphone or earpiece worn inside the ear and two earbuds comprise an earbud headset. Therefore, the terms earbud, headphone, earpiece and headset are used interchangeably throughout the present disclosure. Earbuds used in mobile phone Bluetooth headsets, hearing aids, iPod earphones, personal computer earpieces and many other multimedia devices today are often large and ill fitted to the human ear. Because many earbuds are large, they do not fit into the user's ear canal and do not therefore deliver audio near the user's ear canal for optimal reception by the human ear. Also, ill fitting earbuds may allow extraneous noise into the user's audio experience and even fall out of the user's ear altogether. On the other hand, tight fitting earbuds may cause the user discomfort and pain over extended periods of use.

Fully occluding earbuds may increase pressure in the user's ear and make the user's own voice sound ‘hollow’ or ‘booming.’ When a fully occluding earbud fills the user's ear canal, bone-conducted sound vibrations may be reflected off the earbud back into the ear canal. Compared to a completely open ear canal, full occlusion may amplify low frequency vibrations such as normal talking or chewing which are otherwise undetected in an open ear canal.

For these reasons and more, the present disclosure embodies a partially occluding and ergonomically shaped earbud adapter fitted to a variety of headsets to deliver audio into the user's ear canal for an optimal audio experience. The adapter is shaped from low durometer materials including polymers, elastomers, rubber compositions and silicone. The adapter therefore conforms to the shape of most concha and most auricles and protrudes into the human ear canal to deliver audio into a user's ear canal. The low durometer materials also comprise intrinsic elasticity to restore the adapter to its original configuration. The disclosed earbud adapter therefore provides isolation from extraneous and undesired noise while providing sound isolation for desired audio delivery into the user's ear canal.

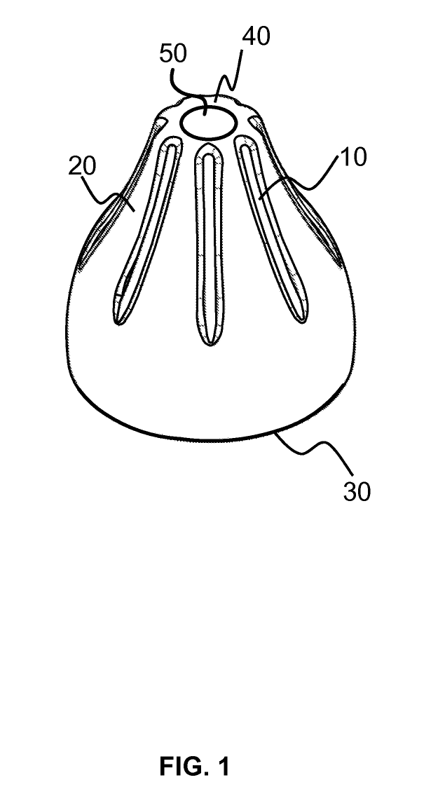

FIG. 1 depicts a top perspective view of the earbud adapter in accordance with an embodiment of the present disclosure. The exterior of the adapter is frusto-conical and substantially tear-drop shaped (shaped also like an umbo in embodiments) and formed with several fluted recesses 10 which set apart finger-like flanges 20 extending from the base 30 toward the tip 40 of the adapter. The tip 40 of the adapter defines an orifice 50. The finger-like flanges 20 grip the inside of a user's ear canal and form an ergonomic seal partially occluding sound from the user's ear canal and therefore providing isolation. The fluted recesses are nominally 0.5 mm recessed into the adapter device exterior and no more than 0.5 mm wide. It should be understood that throughout the present disclosure where nominal values are called out, a minimum and a maximum value may vary from the nominal value by plus or minus 10% unless otherwise specified.

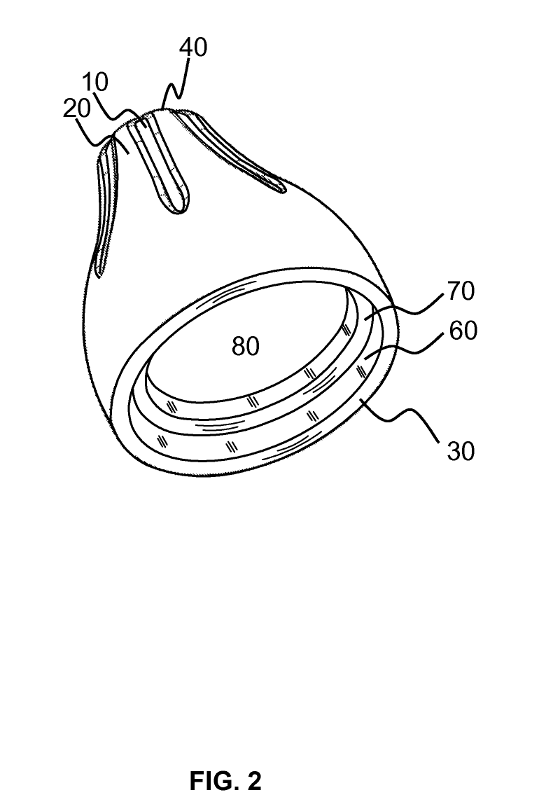

FIG. 2 depicts a bottom perspective view of the earbud adapter in accordance with an embodiment of the present disclosure. The adapter wall, also known as the device wall, near the base 30 comprises an undercut also known as a skirt 60 and a protrusion also known as a rib 70 which secures the headset within the adapter and thus enables a user to position the headset into his or her ear canal. The parabolic cavity 80 between the rib 70 and the orifice channel (not shown) not only holds the earbud headset but also funnels or channels sound from the earbud headset or another audio listening device out the orifice channel and into the ear canal. The rib 70 extends radially inward from the inside wall nominally 1 mm to and is nominally 1 mm thick and comprises one of an arcuate and a polygonal protrusion from the inside wall. A cylindrical skirt shares an exterior device wall with the base and extends a height or length of the base. The skirt is configured to extend nominally 1.5 mm from the base over a headset neck when the headset's earbud is set into the adapter.

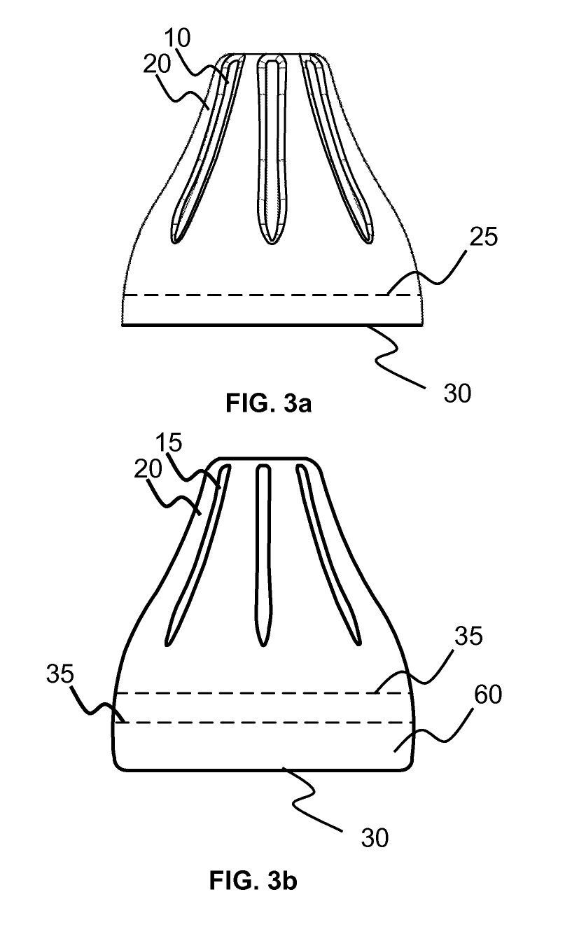

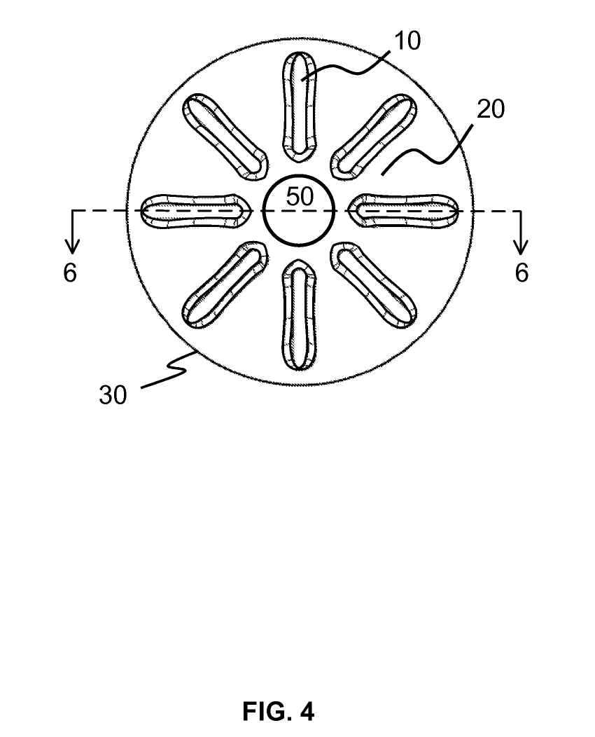

FIG. 3a depicts a side elevational view of a skirtless earbud adapter in accordance with an embodiment of the present disclosure. The fluted recesses 10 accommodate the soft tissues of the inside of the human ear canal while allowing escape of pressure and bone-conducted sounds from the ear canal for high audio clarity and fidelity. The length of the fluted recesses 10, comprise a nominal 9 mm length plus or minus 3 mm. The dotted line 25 indicates the top side of the rib on the inside wall and therefore depicts the rib placement relative to the base 30.

FIG. 3b depicts a side elevational view of a skirted earbud adapter in accordance with an embodiment of the present disclosure. The fluted recesses 15 are more sharply recessed than the gradually sloping fluted recesses 10 in an embodiment of the present disclosure. However, the length and depth of the recesses 15 are similar to the length and depth of the fluted recesses 10. Therefore, the length of the recesses 15, comprise a nominal 9 mm length plus or minus 3 mm. The pair of dotted lines 35, indicate the rib placement and extension of the skirt 60 from the rib to the base 30. The skirt 60 may provide a better adapter fit inside a user's ear for some headsets. The skirt 60 may also provide additional sound isolation.

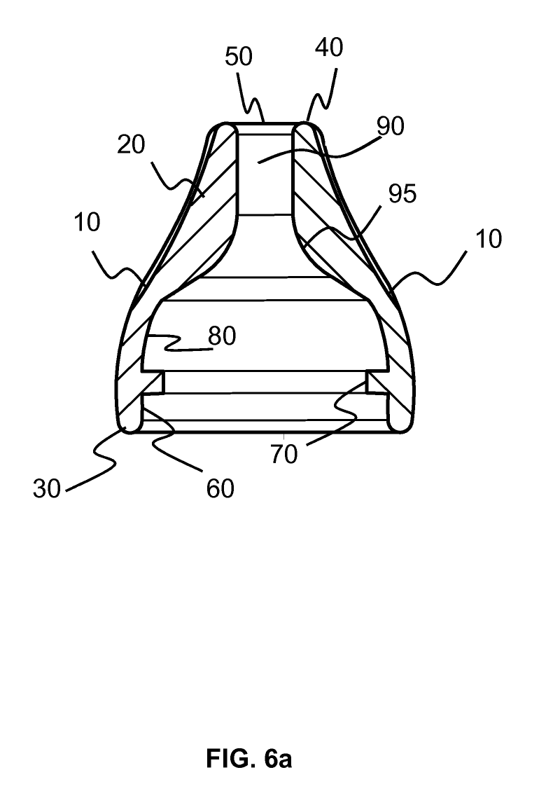

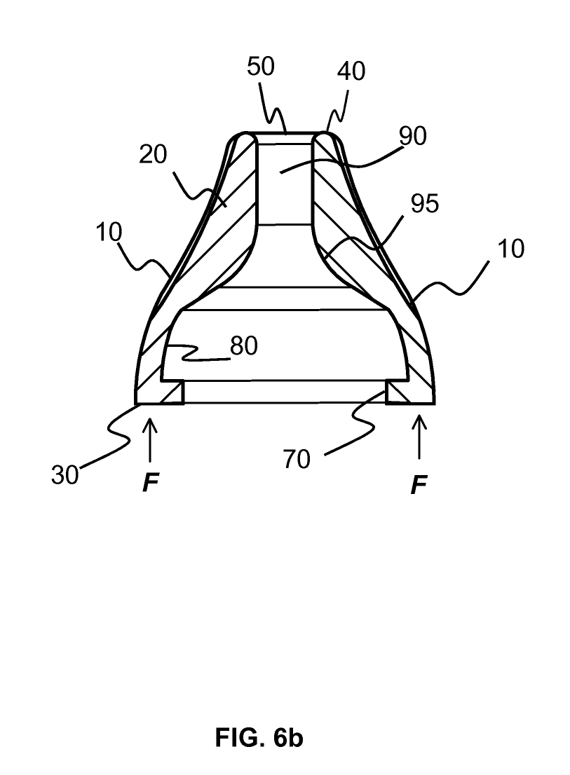

FIG. 4 depicts a top elevational view of the earbud adapter in accordance with an embodiment of the present disclosure. Eight recesses and eight arcuate finger-like flanges are depicted in FIG. 1 though only one of each are called out. The arcuate finger-like flanges form a slight concavity on the exterior of the adapter. Any multiple number of fluted recesses may be formed in embodiments of the present disclosure. The adapter and all its components are composed of low durometer materials to permit comfortable conformance to a variety of ear canal sizes. The broken line labeled 6 on both arrow ends indicates the cross-section shown in FIG. 6a and FIG. 6b discussed below.

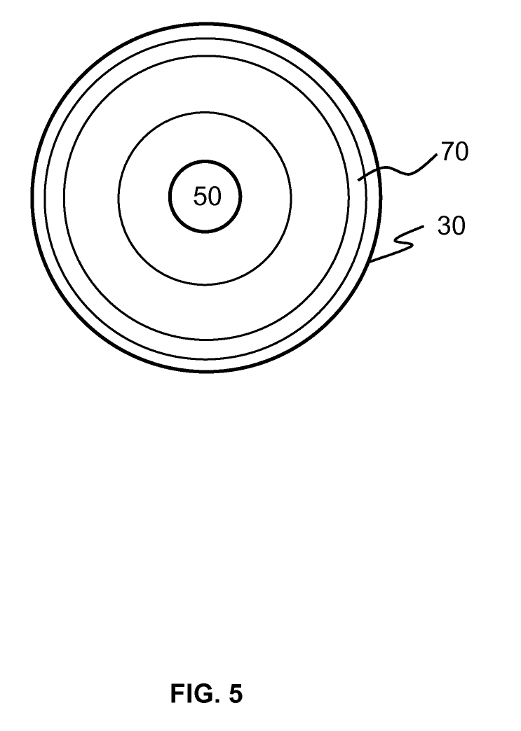

FIG. 5 depicts a bottom elevational view of the earbud adapter in accordance with an embodiment of the present disclosure. The base wall 30 and the bottom protrusion of the rib 70 are clearly shown in near equal thickness. However, embodiments of the disclosure comprise a rib and base wall of variable thickness. Also, though the rib 70 shown is completely circumferential, embodiments of the disclosure also include partial ribs sufficient fit into a circumferential notch in the headset and secure the earbud in the parabolic cavity. The circular line between the rib 70 and the orifice 50 depicts the contour of the inside wall of the adapter.

FIG. 6a depicts a radial cross-sectional view of an earbud adapter through section 6 of FIG. 4 in accordance with an embodiment of the present disclosure. The interior of the adapter formed by the inside wall encloses and secures the earbud circumferential edge in a parabolic concavity 80 formed adjacent the rib 70 adjacent the skirt 60 and near the base 30. Embodiments of the adapter may include the skirt 60 or omit the skirt 60 depending on headset compatibility requirements and manufacturing molds and lots run at any particular time. The parabolic concavity 80 is abutted by a cylindrical channel 90 extending through the adapter to an orifice 50 at the tip 40 to deliver audio into the user's ear canal from the enclosed earbud. The parabolic channel 80 and abutting cylindrical channel 90 allow an efficient transference of all audio frequencies from the earbud into the ear canal with minimal attenuation. The adapter wall is thickest at 95 and may vary in thickness from the tip to the base in order to form a parabolic cavity and to give strength where needed but yet allow flexibility and an ergonomic and comfortable fit for the user. Other lines shown inside the adapter depict the contours of the parabolic cavity and the cylindrical channel.

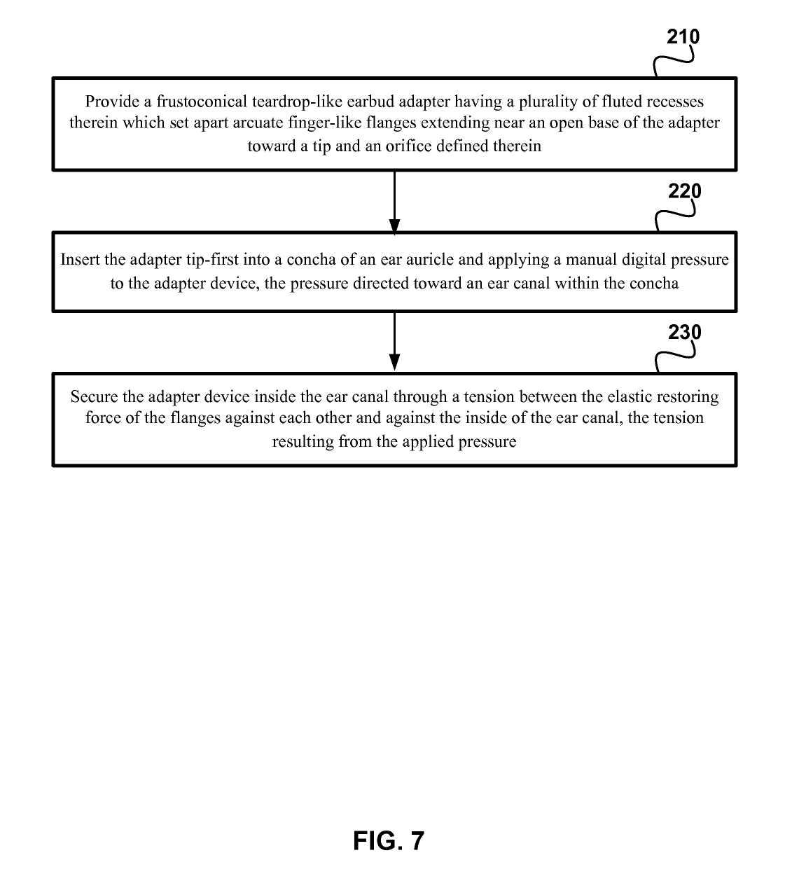

FIG. 6b depicts a radial cross-sectional view through a skirtless earbud adapter through section 6 of FIG. 4 in accordance with an embodiment of the present disclosure. With the exception of the skirt (not depicted), features are similar to those shown in FIG. 6a and therefore reference numbers (callouts) are the same. The vectors marked ‘F’ indicate the manual and digital force applied by a user to insert and set the adapter into an ear as further explained with respect to FIG. 7 below. Also, embodiments of the earbud adapter including a skirt require to similar force vectors to insert and fix a skirted adapter in a user's ear canal.

A length of the channel 90 from the orifice 50 is at least one of a nominal 3.5 mm long and approximately equal to one-third a total elongate length of the adapter. A diameter of the channel is nominally 2.5 mm and no smaller than 2.0 mm and no larger than 3.0 mm. A wall thickness of the adapter at the channel is approximately equal to an inside radius of the channel. A thickness of the device wall near the vertex of the parabolic cavity is approximately twice as thick as the wall at the cylindrical portion

Embodiments of the earbud adapter include thin walls and thick walls between the adapter exterior and interior. It is advantageous for a thin wall 80 portion of the adapter to form an enclosure so that it may be stretched onto a varied assortment of earbud headsets or other audio listening devices. It may also be advantageous for a thicker wall portion to form the parabolic and cylindrical channels to prevent a collapse of the audio channel extending from the earbud to the tip of the adapter. In other words, the variable wall thickness allows the adapter bottom to be flexible and the tip to maintain its shape.

Other embodiments may include fluorescent pigments embedded in a homogeneous low durometer material used to form the earbud adapter. Fluorescent pigments may aid the user in locating the adapters which may be easily misplaced. Embodiments may also include brightly colored pigments used to draw attention to the adapter. The adapter may be composed of hybrid materials and colors suitable to various ornamental designs and various uses.

The disclosed embodiments include low durometer compositions free of Latex, PVC (polyvinyl chloride), phthalate, and BPA (Bisphenol A). The compositions comprising the earbud adapter enable it to be worn inside the human ear for extended periods of time without any deleterious effects to the user. Embodiments of the earbud adapter may also comprise compositions of various eluting agents such as aloe to provide a soothing feel to the user.

Furthermore, the adapter may be comprised of compositions including anti-bacterial materials that retard and deter growth of bacteria on the adapter exterior and interior. The compositions comprising the earbud adapter allow it to be washed with liquid soap and water. The adapter therefore may be maintained through simple and inexpensive means and extend the healthy use of to the disclosed adapter for the user.

Additional embodiments include various patterns and ridges embossed laterally onto the finger-like flanges to enhance their gripping property without adding any discomfort to the user. Also, coatings of various coefficients of friction are comprised in embodiments which enhance the gripping property. Embodiments having deeper fluted recesses also allow the finger-like flanges to move closer together and accommodate smaller ear canals and allow more occlusion of the ear canal when desired. Materials with memory may comprise the finger-like flanges and allow a degree of resiliency from their original shape for a tighter fit into a user's ear canal when desired.

FIG. 7 depicts a flow chart of a method for setting an earbud adapter into an ear canal in accordance with an embodiment of the present disclosure. The method includes 210 providing a frustoconical teardrop-like earbud adapter with multiple fluted recesses therein which set apart arcuate finger-like flanges extending near an open base of the adapter toward a tip and an orifice defined therein. The method also includes 220 inserting the adapter tip-first into a concha of an ear auricle and applying a manual digital pressure to the adapter, the pressure directed toward an ear canal within the concha. The method further includes 230 securing the adapter inside the ear canal through a tension between the elastic restoring force of the flanges against each other and against the inside of the ear canal, the tension resulting from the applied pressure. The insertion of the adapter into the ear may force the flanges toward each other and therefore compress the recesses. The low durometer materials comprising the adapter have intrinsic elastic restoring forces which resist the recess compression and restore the flanges to their original configuration. These elastic restoring forces also push the flanges against the inside of the user's ear canal and therefore fix the adapter inside the ear canal and resist dislodgement during normal activities.

The partially occluding ergonomic earbud adapter disclosed herein is designed to be compatible with at least the following headsets and earbuds: Aliph: Jawbone, Anycom, BlackBerry, Bluedio, Bluespoon, BlueTrek, FoneGear, GoldLantern, Jabra, Just Wireless, LG, MadCatz, Motorola, Plantronics, QuickCell, RocketFish, Samsung, Sony, Sound ID, Wireless Gear and others.

Although specific embodiments of the invention have been described to and illustrated, the invention is not to be limited to the specific forms or arrangements of parts so described and illustrated. The scope of the invention is to be defined by the claims and their equivalents.

What is claimed is:

1. An earbud adapter for a headset or other audio listening device, comprising:
a frustoconical teardrop-like exterior having a plurality of fluted recesses therein which set apart finger-like flanges extending near an open base of the adapter to a tip thereof, the exterior defining one side of a device wall;
a device wall extending from the base to an orifice defined in the tip, an inside of the wall defining a radial channel extending cylindrically inward from the orifice and an adjacent parabolic cavity extending to the base; and
to a rib protruding from the inside wall near the base, the rib configured to fit into a circumferential notch in an earbud of the headset and secure the earbud in the cavity and thus enable a user to position the headset into an ear canal.

2. The earbud adapter of claim 1, further comprising a cylindrical skirt sharing an exterior wall with the base and extending a height of the base, the skirt configured to extend nominally 1.5 mm from the base over an earbud neck when the earbud is set into the adapter.

3. The earbud adapter of claim 1, wherein the rib extends radially inward from the inside wall nominally 1 mm and is nominally 1 mm thick and comprises one of an arcuate and a polygonal protrusion from the inside wall.

4. The earbud adapter of claim 1, wherein the finger-like flanges are configured to grip the inside of an ear canal and form an ergonomic seal therewith and partially occlude outside noise from the ear canal while providing sound isolation for high fidelity audio delivery into the ear canal.

5. The earbud adapter of claim 1, wherein the fluted recesses are configured to allow bone-conducted sound vibrations comprising normal talking and chewing to escape the user's ear canal from being reflected off the earbud adapter and back into the ear canal.

6. The earbud adapter of claim 1, wherein the parabolic cavity between the rib and the channel is configured to funnel sound from the earbud into the ear canal.

7. The earbud adapter of claim 1, wherein the fluted recesses are nominally 0.5 mm recessed into the adapter device exterior and no more than 0.5 mm wide.

8. The earbud adapter of claim 1, wherein a length of the channel from the orifice is at least one of a nominal 3.5 mm long and approximately equal to one-third a total elongate length of the adapter.

9. The earbud adapter of claim 1, wherein a diameter of the channel is nominally 2.5 mm and no smaller than 2.0 mm and no larger than 3.0 mm.

10. The earbud adapter of claim 1, wherein a thickness of the device wall near the vertex of the parabolic cavity is configured to be approximately twice as thick as the wall at the cylindrical portion and therefore strengthen the cylindrical portion from movement of the more flexible and thinner wall near the base.

11. The earbud adapter of claim 1, wherein a length of the fluted recesses comprises a nominal 9 mm length and is no shorter than 3 mm and no longer than 12 mm.

12. The earbud adapter of claim 1, further comprising low durometer and elastic materials including polymers, elastomers, rubber compositions, and silicone configured to conform to the shape of most human concha and auricles of the ear and configured to stretch-fit over the earbud of a plurality of audio listening devices.

13. The earbud adapter of claim 1, further comprising fluorescent pigments embedded in a homogeneous material to aid the user in locating misplaced adapters.

14. The earbud adapter of claim 1, further comprising at least one of a plurality of various patterns and ridges embossed laterally onto the finger-like flanges to enhance their gripping properties without adding any discomfort to the user.

15. The earbud adapter of claim 1, further comprising one of a plurality of coatings applied to the adapter exterior wherein the coatings are configured to have various coefficients of friction to enhance the gripping properties of the finger-like flanges.

16. The earbud adapter of claim 1, further comprising a composition of a plurality of anti-bacterial materials and coatings that retard and deter the growth of bacteria on the adapter exterior and inside walls.

17. The earbud adapter of claim 1, further comprising one of a plurality of compositions of various eluting agents including aloe configured to provide a soothing feel to the user.

18. An earbud adapter device for a headset or other audio listening device, comprising:
a frustoconical teardrop-like exterior having a plurality of fluted recesses therein which set apart arcuate finger-like flanges extending near an open base of the adapter to a tip thereof, the exterior defining one side of a device wall;
a device wall extending from the base to an orifice defined in the tip, an inside of the wall defining a radial channel extending cylindrically inward from the orifice and an adjacent parabolic cavity extending to the base;
a rib protruding from the inside wall near the base, the rib configured to fit into a circumferential notch in an earbud of the headset and therefore secure the earbud into the cavity; and
a cylindrical skirt configured to share an exterior wall with the base and to extend a height of the base and to extend from the base over an earbud neck when the earbud is set into the adapter device.

19. A method of setting an earbud adapter into an ear canal, comprising:
providing a frustoconical teardrop-like earbud adapter having a plurality of fluted recesses therein which set apart arcuate finger-like flanges extending near an open base of the adapter toward a tip and an orifice defined therein;
inserting the adapter tip-first into a concha of an ear auricle and applying a manual digital pressure to the adapter device, the pressure directed toward an ear canal within the concha; and
securing the adapter inside the ear canal through a tension between the elastic restoring force of the flanges against each other and against the inside of the ear canal, the tension resulting from the applied pressure.
